(19) United States
(12) Patent Application Publication
(10) Pub. No.: US 2025/0174219 A1
(43) Pub. Date: May 29, 2025

(54) METHOD OF CONTROLLING TRAVELING SOUND OF ELECTRIC VEHICLE USING MOTOR VIBRATION AND VIRTUAL TRANSMISSION SIGNAL

(71) Applicants: Hyundai Motor Company, Seoul (KR); Kia Corporation, Seoul (KR)

(72) Inventors: Dong-Chul LEE, Seoul (KR); Kyoung-Jin Noh, Whasung-Si (KR); Jeong-Soo Eo, Whasung-Si (KR); Ji-Won Oh, Whasung-Si (KR); In-Soo Jung, Whasung-Si (KR)

(73) Assignees: Hyundai Motor Company, Seoul (KR); Kia Corporation, Seoul (KR)

(21) Appl. No.: 18/737,649

(22) Filed: Jun. 7, 2024

(30) Foreign Application Priority Data
Nov. 29, 2023 (KR) 10-2023-0169931

(51) Int. Cl. G10K 11/178; B60L 15/20

(52) U.S. Cl. CPC G10K 11/1781; B60L 15/20; B60L 2240/423; G10K 2210/121; G10K 2210/1282

(57) ABSTRACT

A method of controlling an electric vehicle traveling sound using motor vibration and a virtual transmission signal includes extracting, by a signal processing controller, a vibration level of an N^{th} order component with a largest linearity for a motor output torque among order components extracted from a vibration signal of a rotating electric vehicle (EV) motor and a virtual engine RPM, determining, by the signal processing controller, a frequency for each order component by transforming revolutions per minute (rpm) of the EV motor into a frequency, and setting, by the signal processing controller, an EV mode traveling sound by applying the vibration level of the N^{th} order component to a level of the frequency for each order component to be output and re-arranging the order components so that the virtual engine revolutions per minute (rpm) reflects a traveling mode shifted according to a virtual gear stage number.

### CROSS-REFERENCE TO RELATED APPLICATION

The present application claims priority to Korean Patent Application No. 10-2023-0169931, filed on Nov. 29, 2023, the entire contents of which is incorporated herein for all purposes by this reference.

### BACKGROUND OF THE PRESENT DISCLOSURE

### Field of the Present Disclosure

The present disclosure relates to a method of controlling a traveling sound of an electric vehicle based on motor vibration, which controls the traveling sound of the electric vehicle based on the motor vibration and a virtual transmission signal of the electric vehicle using a motor as a power source.

### Description of Related Art

Recently, with the advent of vehicles that do not make engine noise, such as electric vehicles (EV) capable of traveling using a motor, it is becoming mandatory for eco-friendly vehicles to be equipped with noise generating devices. In general, noise generated by vehicles causes some discomfort to not only drivers but also pedestrians around the vehicles, but the noise functions to increase pedestrians' vehicle recognition ability to recognize surrounding vehicles through vision and hearing, preventing traffic accidents.

Therefore, traveling sound control for EVs has been developed to store and play virtual sounds, and this is because, unlike internal combustion engine vehicles, the EVs are very quiet during acceleration/deceleration and only high-frequency electromagnetic noise is generated.

A recent traveling sound control technology is recognized as a marketable aspect of vehicles by improving the driver's driving pleasure through hearing and vision. Therefore, there is a need to store and generate music or sounds suitable for the EVs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a technology of controlling traveling sounds desired by customers according to the performance of vehicles based on motor characteristics of electric vehicles (EV) replacing power of general internal combustion engines and provides a technology of controlling a traveling sound of the EV, which may extract an order component of motor vibration having high correlation with motor output characteristics of the EV corresponding to the power performance of the internal combustion engine by a virtual engine revolutions per minute (rpm) and a virtual gear stage number in real time, and then implement traveling sounds according to the power performance characteristics of the vehicle.

A method of controlling an electric vehicle traveling sound using motor vibration and a virtual transmission signal according to an exemplary embodiment of the present disclosure includes extracting, by a signal processing controller, a vibration level of an Ni order component with a largest linearity for a motor output torque among order components extracted from a vibration signal of a rotating electric vehicle (EV) motor and a virtual engine RPM, calculating, by the signal processing controller, a frequency for each order component by transforming an RPM of the EV motor into a frequency, and setting, by the signal processing controller, an EV mode traveling sound by applying the vibration level of the N^{th} order component to a level of the frequency for each order component to be output and re-arranging the order components so that the virtual engine RPM reflects a traveling mode shifted according to a virtual gear stage number.

Furthermore, the N^{th} order component may be an N^{th} order component of which a coefficient of determination R² is 90% or more, and the order component may be determined from a vibration sensor configured to detect the vibration signal of the EV motor.

Furthermore, the virtual engine RPM may be determined by Equation 1, [Equation 1] Virtual engine RPM=actually measured motor RPM×gear ratio of the number of virtual target stages.

In addition, for the virtual gear stage number, a difference between a virtual target gear stage and a virtual current gear stage may be caused by a transmission proceeding rate of Equation 2, [Equation 2] Transmission proceeding rate=(virtual engine RPM−current gear stage RPM)/(target gear stage RPM−current gear stage RPM)×100%.

Another method of controlling an electric vehicle traveling sound using motor vibration and a virtual transmission signal according to an exemplary embodiment of the present disclosure includes extracting, by a signal processing controller, an N^{th} order component with a largest linearity for a motor output torque among order components extracted from a vibration signal of a rotating electric vehicle (EV) motor and a virtual engine RPM, determining, by the signal processing controller, a frequency for each order component by transforming an RPM of the EV motor into a frequency, and setting, by the signal processing controller, the EV mode traveling sound by applying a vibration level of the N^{th} order component to a level of a frequency for each order component to be output and re-arranging the order components, wherein the virtual engine RPM is changed according to the virtual gear stage number.

Furthermore, the extracting of the N^{th} order component may include performing Fast Fourier Transformation (FFT) on the vibration signal, and performing re-sampling through a non-equispaced Fast Fourier Transformation (NFFT).

Furthermore, the extracting of the N^{th} order component may include extracting the N^{th} order component using order tracking analysis on the EV motor and an RPM-based band-pass filter.

The present disclosure provides a technology of controlling the traveling sound, which matches with the performance of the vehicle and is desired by the customer, based on the motor vibration signal and virtual transmission signal of the EV, and it is possible to extract the order component of the motor vibration having high correlation with the motor output characteristics of the EV, and then implement the traveling sound that is available in the internal combustion engine through the virtual engine RPM and the number of gear stages to match the power performance characteristics of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an electric vehicle (EV) to which the present disclosure is applied.

FIG. 2 is a view exemplarily illustrating signal and data flows from an input signal to an output of a traveling sound according to an exemplary embodiment of the present disclosure.

FIG. 3A, FIG. 3B and FIG. 3C are graphs illustrating a change in output torque for each load and a change in order level according to a position of a vibration sensor.

FIG. 4 is a block diagram of a control algorithm according to an exemplary embodiment of the present disclosure from the input signal to a sound output.

FIG. 5A and FIG. 5B are views for describing a process and a result of extracting an N^{th} order level using a Fast Fourier Transformation (FFT) analysis algorithm applied to the present disclosure.

FIG. 6A, FIG. 6B, and FIG. 6C are views for describing a process and a result of extracting an N^{th} order level using an order tracking algorithm applied to the present disclosure.

FIG. 7 is a view for describing a process of determining a virtual engine RPM and the number of virtual transmission gear stages.

FIG. 8A and FIG. 8B are views comparing motor vibration signals before and after the virtual transmission signal of the present disclosure is applied.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, and these embodiments are examples and may be implemented in various different forms by those skilled in the art to which the present disclosure pertains, and thus are not limited to various exemplary embodiments included herein.

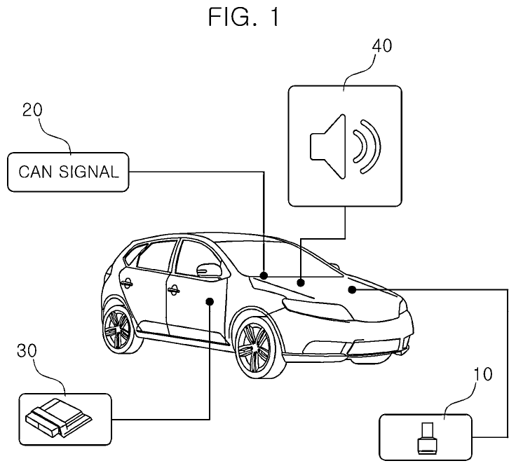

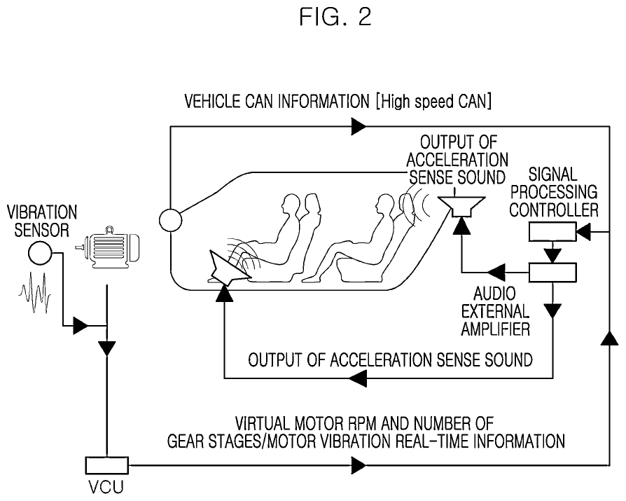

FIG. 1 is a view exemplarily illustrating an electric vehicle (EV) to which the present disclosure is applied, and FIG. 2 is a view exemplarily illustrating signal and data flows from an input signal to an output of a traveling sound according to an exemplary embodiment of the present disclosure.

Referring to FIG. 1, to be mounted to an EV to implement the present disclosure, a vibration sensor 10 for measuring a vibration signal generated when a motor rotates, a Controller Area Network (CAN) signal 20 connected to the vehicle via CAN communication, a signal processing controller 30 for processing the vibration signal and the CAN signal, and a sound output device 40 are included.

The vibration signal of the motor measured by the vibration sensor 10 is input to the signal processing controller 30, and vibration characteristics according to real-time motor rotation are measured. The vibration sensor 10 may be used by being selected from a vibration sensor for acquiring an analog signal and a micro elector-mechanical systems (MEMS) sensor that includes a knocking sensor method capable of converting an analog signal into a digital signal through a digital signal conversion module and processes the digital signal by itself.

The CAN signal 20 may obtain a motor RPM, an opening amount of an accelerator pedal, and a vehicle speed in real time, and may include not only information related to a drive mode change, a motor torque, and a vehicle traveling characteristics, but also in an exemplary embodiment of the present disclosure, signals for a virtual engine RPM and a virtual gear stage number.

The signal processing controller 30 may be configured to determine traveling conditions or the driver's intention on the presence or absence of acceleration/deceleration/constant speed traveling from the vibration signal and the CAN signal, which are input signals, generate a target traveling sound signal using the motor RPM and the vibration signal, and transmit the target traveling sound signal to the sound output device 40 as output data. As the signal processing controller, an in-vehicle audio digital signal processor (DSP) may be applied. The DSP may be used in voice coding to digitize voice, which is an analog signal, and is an integrated circuit for allowing mechanical devices to quickly process digital signals.

The sound output device 40 may output the output data received from the signal processing controller through a speaker provided in an engine compartment in which the motor is embedded to output a specific frequency band. Furthermore, the sound output device may be mounted on an exterior of the vehicle, which includes front, rear, and side surfaces of the vehicle, rather than the inside of the engine compartment for protecting pedestrians and output through audio speakers provided inside the vehicle for the driver or passengers, and may be a thin type speaker or membrane playable device.

FIG. 2 is a view exemplarily illustrating a process of obtaining real-time information and motor RPM information related to the motor vibration from the vibration sensor and the vehicle CAN signal, performing calculation in the signal processing controller, and then outputting acceleration sense sound to the interior of the vehicle through an external audio amplifier. As described above, a position of the sound output device may include not only the interior of the vehicle, but also the outside of the vehicle, the inside of the engine compartment, and the like. In an exemplary embodiment of the present disclosure, the virtual engine RPM and the virtual gear stage number are generated by a vehicle control unit (VCU) from the real-time vibration signal information obtained from the vibration sensor and transmitted to the signal processing controller.

A vibration level caused by the rotation of the EV motor is a relatively low value compared to a level caused by combustion of an internal combustion engine. Therefore, it is important to select the position of the sensor, which may accurately extract a small change in vibration level. A method of selecting the position of the sensor is as follows.

First, a location with a high amplitude while sweeping a frequency through the analysis of a structural analysis model of the EV motor is selected, and since the position should be a flat surface to mount the vibration sensor, a position with high amplitude sensitivity with respect to the flat surface should be selected. Furthermore, a vibration measurement direction of the vibration sensor is measured in a direction perpendicular to a seating surface. In other words, an amplitude change in the direction perpendicular to the seating surface may be predicted through the analysis.

After the structural analysis, by simultaneously measuring an output torque change and a level change for each order of the motor vibration for each load of the motor while changing the position of the sensor and performing regression on the measured values of the output torque change and the order level change, a position at which a maximum amplitude is generated and the high sensitivity is present may be selected to extract the motor output characteristics and an N^{th} order component in which a coefficient of determination R² is 0.9 or more, and a position at which linearity and level change characteristics best appear according to the characteristics of the amplitude caused by the motor vibration may be selected.

The power performance of the motor in the EV is expressed as an output torque of the motor. In an exemplary embodiment of the present disclosure, to control the traveling sound based on the motor vibration, a component with high correlation with the output torque trend of the motor among the order degree and order level characteristics of the motor based on the motor RPM among many pieces of information related to the vibration signal of the motor should be extracted and selected as the N^{th} order component. The order component appears differently depending on the internal structure of the motor including the number of magnetic cores and the like.

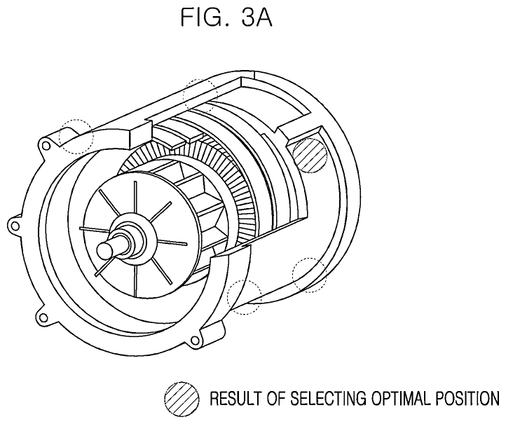

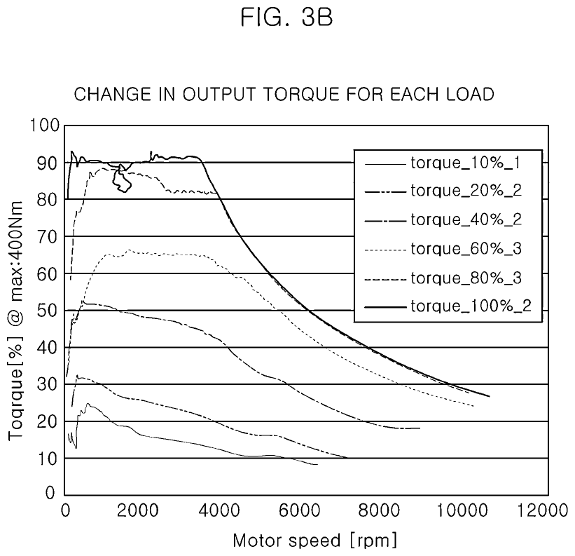

FIG. 3A is an example of a position for the selection of an optimal position of the vibration sensor provided on the motor, FIG. 3B illustrates that an X-axis is a motor RPM, a Y-axis is an output torque and illustrates a change in output torque for each load, and FIG. 3C illustrates that an X-axis is a motor RPM, and a Y-axis is a change in level (dB) at the order for each N^{th} load. These are to compare graphs of the output torque, order degree, and order level changes depending on measured positions. In other words, the correlation between linearity of the output torque change for each load of the motor and linearity factors according to the load change among many order components of the vibration measured from the motor is determined by comparing the order components.

As an example of the result, a graph of the motor RPM-order degree (N^{th})-order level (dB) is completed, and as an order component with high motor output torque and high correlation, a 24^{th} order of which the coefficient of determination R² is 0.9 or more is determined as a reference Ref order.

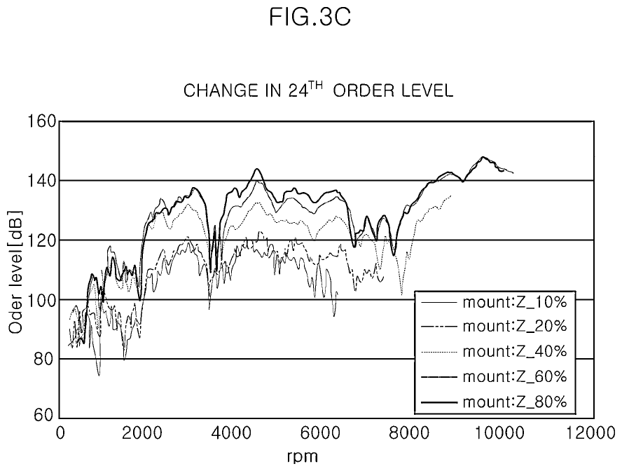

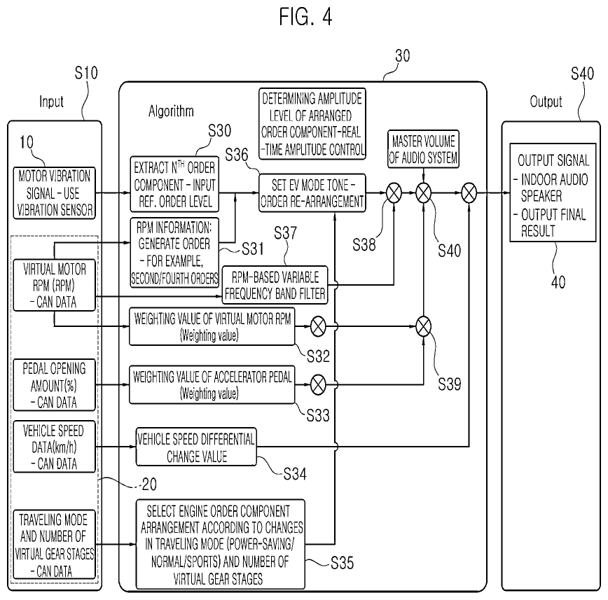

FIG. 4 is a block diagram of a control algorithm according to an exemplary embodiment of the present disclosure from various signal inputs (S10) to the output (S40) from the sound output device.

As an input signal, the vibration signal of the EV motor is measured by use of the vibration sensor 10, and the EV motor RPM, the pedal opening amount, vehicle speed data, a traveling mode, the virtual engine RPM, and the virtual gear stage number are input from the CAN signal 20. The algorithm from the signal input (S10) to the output (S40) is determined by the signal processing controller 30, and a final output is executed by the sound output device 40 including indoor/outdoor audio speakers.

An N^{th} order component is extracted from the motor vibration signal obtained through the vibration sensor 10, this is determined as the reference Ref order of which the coefficient of determination R² is 0.9 or more, and the level of the N^{th} order component, that is, the reference Ref order component is determined (S30).

By initially calculating the reference Ref order component from the N^{th} order component once and then inputting the reference Ref order component to the signal processing controller, this may be always used as the reference Ref order component. Meanwhile, by extracting the N^{th} order component from the motor vibration signal at specific times, the reference Ref order component may be set to be automatically determined by the signal processing controller.

Meanwhile, in S31, an order component (e.g., a 2^{nd} order/4^{th} order) generated for the motor RPM obtained in real time may be generated, and the motor RPM used at the instant time is the virtual motor RPM. The virtual motor RPM may be shifted by a virtual transmission gear stage, and in the description of the present application, is expressed as the virtual engine RPM.

When the N^{th} order component, which is the reference of the order level, is determined in S30, the order re-arrangement is made by matching the order component generated in S31 (S36). Meanwhile, in S36, an amplification degree of the level for the arranged order component may be determined, and the real-time amplification control may be performed.

The engine order component arrangement may be selected according to which mode the traveling mode, among the signal input (S10) information and the traveling mode in S35 from input information related to the virtual gear stage number, is among power-saving/normal/sports modes and information related to the virtual gear stage number, and, upon the order re-arrangement in S36, this may be additionally reflected.

The virtual engine RPM and the virtual gear stage number may be set to match an EV concept and set to output virtual gear transmission information of a fast transmission pattern in the case of the EV that values performance and output virtual gear transmission information of a soft transmission pattern in the case of the EV that aims for luxury. For the virtual engine RPM and the virtual gear stage number, virtual engine RPM information, a virtual transmission time point, and information related to the virtual gear stage number of a multi-stage (sixth stage, eighth stage, or the like) pattern suitable for the characteristics of the EV through a virtual gear shift (VGS) algorithm are provided as input values of the signal processing controller 30 from the signal input S10 through the VCU.

Meanwhile, the EV mode traveling sound set in S36 may be interworked with input signal or external signals, and thus calculated values may be changed selectively (S38, S39, and S40). After passing through a variable frequency band filter based on the virtual engine RPM (S37), the result may be applied to S38.

The band filter is a band-pass filter and is a filter for removing a component of any frequency or lower and a component of any frequency or higher from the input signal and outputting frequencies only in a predetermined band. The band filter may also be configured by a combination of a low-pass filter and a high-pass filter. Therefore, in S38, the band filter may be applied to implement the EV mode traveling sound only in a predetermined band region.

To reflect a change in power performance of the vehicle in the EV traveling sound control and implement a sound matching the driver's acceleration intention, a weighting value may be imposed on the virtual engine RPM may be imposed (S32), and a weighting value may also be imposed on the opening amount of the accelerator pedal (S33).

Furthermore, both results of S32 and S33 may be applied and selected (S39). Furthermore, for vehicle speed data, a vehicle speed differential change value may be applied (S34). The vehicle speed differential change value may be applied to an immediately preceding operation of the output (S40), that is, the last operation of the signal processing controller 30.

Meanwhile, the algorithm for extracting the N^{th} order component representing the characteristics and linearity of the motor output torque may be selectively determined depending on a calculation speed, accuracy, a calculation amount, and the like.

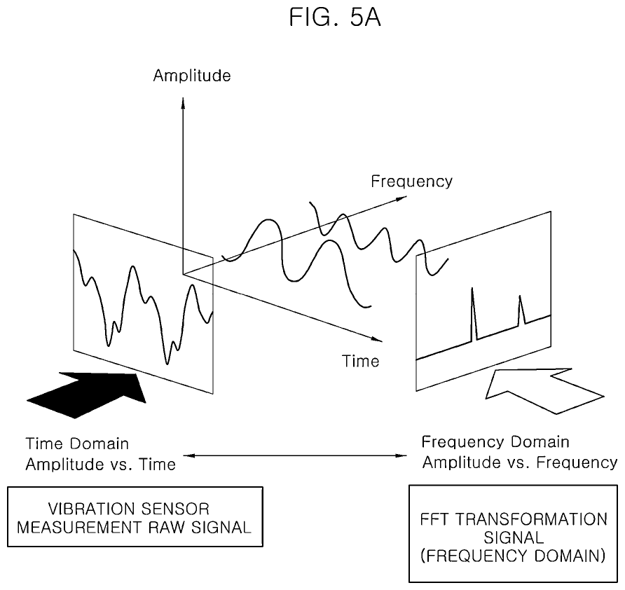

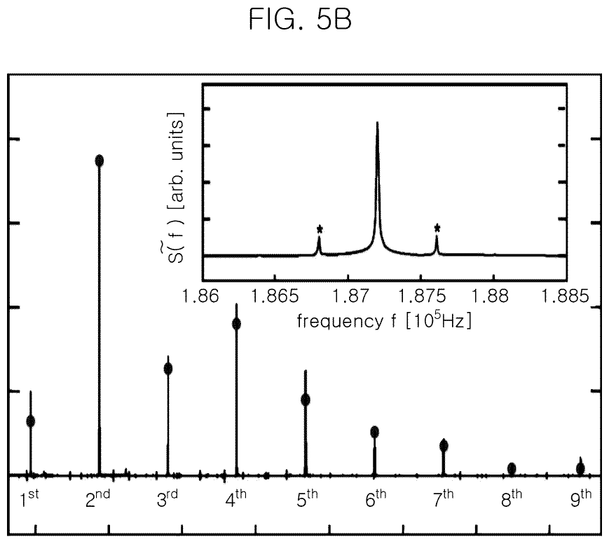

FIG. 5A and FIG. 5B illustrate a case in which a Fast Fourier Transformation (FFT) algorithm having an advantage in terms of accuracy is applied. FIG. 5A is a view exemplarily illustrating that time data is transformed into frequency data, and the FFT may be performed on a region measured in a very short time, and a frequency resolution is low. The frequency resolution means that how closely a value of the corresponding frequency band may be observed at intervals when a desired signal is observed in a frequency domain. Therefore, a non-equispaced Fast Fourier Transformation (NFFT) technique may be applied additionally. By forcibly adding additional M zero-padding data to increase a resolution, it is possible to maintain raw data information measured by the vibration sensor. FFT data re-sampled to a level of 2 Hz may be finally obtained to extract an accurate value of the N^{th} order component using the motor RPM. To the present end, the resolution may be re-sampled to the level of 2 Hz by applying the NFFT technique to perform zero padding as much as the number of insufficient data. FIG. 5B illustrates a result of selectively obtaining only data of which the data order is an N^{th} component among the values extracted using an FFT analysis algorithm.

The entire algorithm to which this is applied includes calculating an order component from the vibration signal of a rotating EV motor, extracting an N^{th} order component with the largest linearity for a motor output torque among the calculated order components, calculating a frequency for each order component by transforming a virtual RPM of the EV motor into a frequency, setting an EV mode traveling sound by applying a vibration level of the N^{th} order component to a level of the frequency for each order component to be output to re-arrange the order components, and outputting the set EV mode traveling sound.

The extracting of the N^{th} order component may control the traveling sound of the EV motor of the EV based on the motor vibration that extracts the N^{th} order component through FFT-transforming the vibration signal and performing re-sampling through an NFFT.

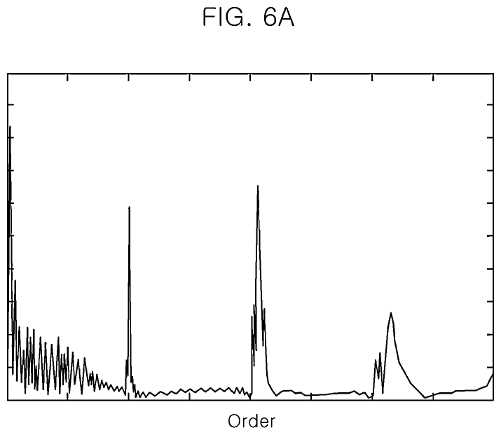

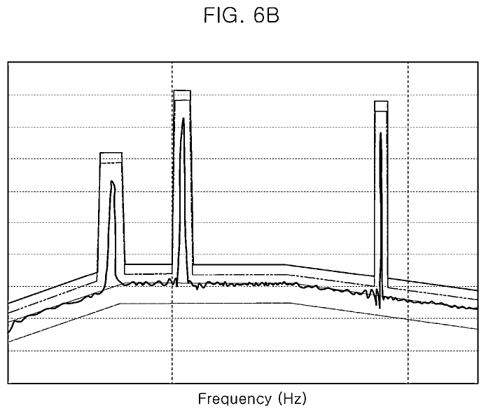

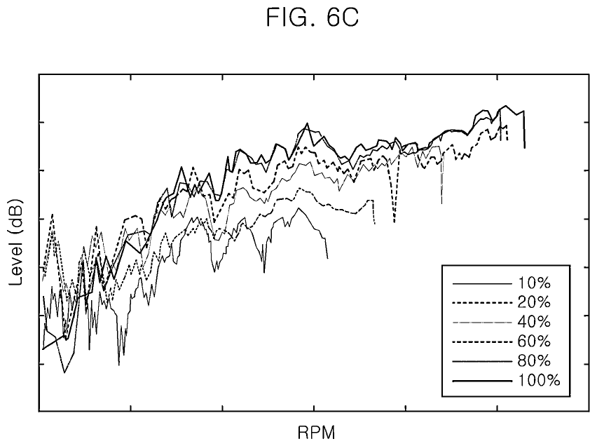

FIG. 6A, FIG. 6B, and FIG. 6C illustrate a result of extracting the N^{th} order component based on the virtual engine RPM information by applying an order tracking algorithm with a small amount of calculations using an algorithm for extracting the N^{th} order component representing the characteristics and linearity of the motor output torque. First, in FIG. 6A, an order component of the vibration signal is extracted through the order tracking calculation, and in FIG. 6B, the band filter is applied to calculate the N^{th} order according to a change in virtual engine RPM. The band filter is a band-pass filter and is a filter for removing a component of any frequency or lower and a component of any frequency or higher from the input signal and outputting frequencies only in a predetermined band, and in FIG. 6B, an X-axis is a frequency, and the N^{th} order component is extracted by applying the band-pass filter. FIG. 6C is a view exemplarily illustrating the level of the N^{th} order component of the virtual engine RPM for each load.

The entire algorithm to which this is applied may control the traveling sound of the EV motor of the EV by calculating the order component from the vibration signal of the rotating EV motor, extracting the N^{th} order component using the order tracking analysis and the RPM-based band-pass filter for the EV motor among the calculated order components, calculating the frequency for each order component by transforming the RPM of the EV motor into the frequency, setting the EV mode traveling sound by applying the vibration level of the N^{th} order component to the level of the frequency for each order component to be output to re-arrange the order components, and outputting the set EV mode traveling sound.

FIG. 7 illustrates changes in virtual transmission signal and the virtual gear stage number. There is a change between an actual RPM of the EV motor and RPM at virtual gear 1^{st}-2^{nd}-3^{rd}-4^{th} stages, and the virtual engine RPM is implemented so that a delay for transmission occurs between a virtual target gear stage and a virtual current gear stage according to the change in the virtual gear stage number.

The virtual engine RPM is a reference for the generation of the overall virtual effect and expressed as in Equation 1 below. In the instant case, k may be determined by any one or more of a delay due to connection between a virtual torque and inertia, a transmission proceeding rate due to a clutch operation, and a virtual idling RPM and in an ideal case, may be 1.

The transmission proceeding rate is the reference of the generation of transmission intervention torque and is expressed as in Equation 2 below. When the virtual engine RPM follows a target gear stage RPM at a current gear stage RPM, the transmission proceeding rate is smaller than 100%, and when the virtual engine RPM is equal to the target gear stage RPM, the transmission proceeding rate is 100% completed.

$$Virtual engine RPM = k \times actually measured motor RPM \times gear ratio of the number of virtual target stages \qquad [ Equation 1 ]$$

$$Transmission proceeding rate = ( virtual engine RPM - current gear stage RPM ) / ( target gear RPM - current gear stage RPM ) \times 100 \% \qquad [ Equation 2 ]$$

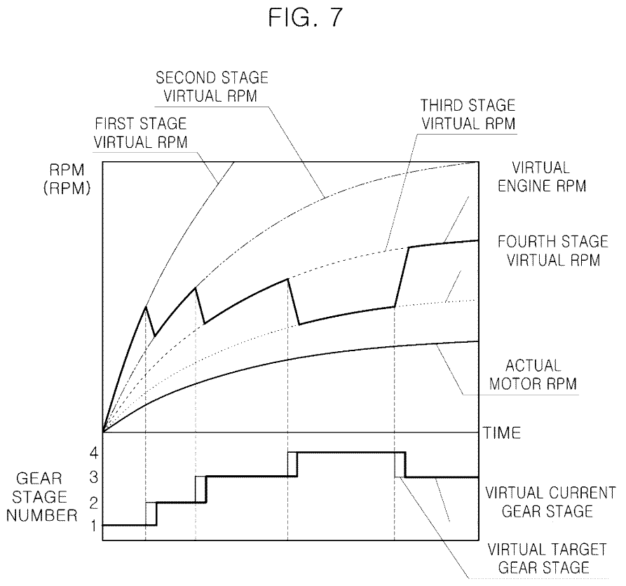

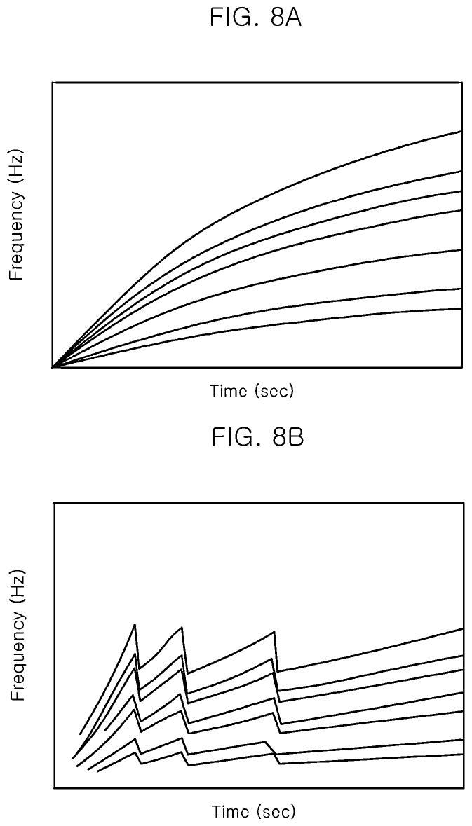

FIG. 8A and FIG. 8B illustrate a result of comparing before and after the virtual transmission signal and the virtual gear stage number according to an exemplary embodiment of the present disclosure are applied and is a change in frequency over time. This illustrates the order component with high correlation with the motor torque by extracting the vibration component, and a required order component is generated by use of motor RPM information, a level of the generated order component is set by the algorithm in which the vibration signal is synthesized, and furthermore to simulating an internal combustion engine generation sound upon acceleration traveling, by additionally applying the virtual transmission signal of FIG. 7, the frequency of the order component over time is changed depending on the transmission pattern generated by the virtual transmission signal.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling an electric vehicle (EV) traveling sound using motor vibration and a virtual transmission signal, the method comprising:
extracting, by a signal processing controller, a vibration level of an N^{th} order component with a largest linearity for a motor output torque among order components extracted from a vibration signal of a rotating EV motor and a virtual engine revolutions per minute (RPM);
determining, by the signal processing controller, a frequency for each order component by transforming an RPM of the EV motor into a frequency; and
setting, by the signal processing controller, an EV mode traveling sound by applying the vibration level of the N^{th} order component to a level of the frequency for each order component to be output and re-arranging the order components so that the virtual engine RPM reflects a traveling mode shifted according to a virtual gear stage number.

2. The method of claim 1, wherein the N^{th} order component is an N^{th} order component of which a coefficient of determination R² is 90% or more.

3. The method of claim 1, wherein the order components are determined from a vibration sensor configured to detect the vibration signal of the EV motor.

4. The method of claim 1, wherein the virtual engine RPM is determined by Equation 1,
$$Virtual engine RPM = actually measured motor RPM \times gear ratio of the number of virtual target stages . \qquad [ Equation 1 ]$$
$$The method of claim 1 , wherin for the virtual gear stage number , a difference between a virtual target gear stage and a virtual current gear stage is caused by a tranmission proceeding rate of Equation 2 , \qquad 5.$$
$$Transmission proceeding rate = ( virtual engine RPM - current gear stage RPM ) / ( target gear RPM - current gear stage RPM ) \times 100 \% . \qquad [ Equation 2 ]$$

6. The method of claim 1, further including outputting the set EV mode traveling sound,
wherein an output volume is adjusted by the signal processing controller by applying a frequency band-pass filter based on the RPM of the EV motor before the outputting.

7. The method of claim 1, further including outputting the set EV mode traveling sound,
wherein an output volume is adjusted by imposing a weighting value on the RPM of the EV motor before the outputting.

8. The method of claim 1, further including outputting the set EV mode traveling sound,
wherein an output volume is adjusted by imposing a weighting value on a pedal opening amount before the outputting.

9. The method of claim 1, further including outputting the set EV mode traveling sound,
wherein an output volume is adjusted by determining a vehicle speed differential change value from vehicle speed data before the outputting.

10. The method of claim 1, wherein in the setting of the EV mode traveling sound, the order components according to a change in the traveling mode are disposed selectively.

11. A method of controlling an electric vehicle (EV) traveling sound using motor vibration and a virtual transmission signal, the method comprising:
extracting, by a signal processing controller, an N^{th} order component with a largest linearity for a motor output torque among order components extracted from a vibration signal of a rotating EV motor and a virtual engine RPM;
determining, by the signal processing controller, a frequency for each order component by transforming an RPM of the EV motor into a frequency; and
setting, by the signal processing controller, an EV mode traveling sound by applying a vibration level of the N^{th} order component to a level of a frequency for each order component to be output and re-arranging the order components,
wherein the virtual engine RPM is changed according to a virtual gear stage number.

12. The method of claim 11, wherein the extracting of the N^{th} order component includes performing Fast Fourier Transformation (FFT) on the vibration signal, and performing re-sampling through a non-equispaced Fast Fourier Transformation (NFFT).

13. The method of claim 11, wherein the extracting of the N^{th} order component includes extracting the N^{th} order component using order tracking analysis on the EV motor and an RPM-based band-pass filter.

14. An apparatus of controlling an electric vehicle (EV) traveling sound using motor vibration and a virtual transmission signal, the apparatus comprising:
a processor; and
a non-transitory storage medium containing program instructions,
wherein the processor is configured for, by executing the program instructions:
extracting a vibration level of an N^{th} order component with a largest linearity for a motor output torque among order components extracted from a vibration signal of a rotating EV motor and a virtual engine revolutions per minute (RPM);
determining a frequency for each order component by transforming an RPM of the EV motor into a frequency; and
setting an EV mode traveling sound by applying the vibration level of the N^{t}h order component to a level of the frequency for each order component to be output and re-arranging the order components so that the virtual engine RPM reflects a traveling mode shifted according to a virtual gear stage number.

15. The apparatus of claim 14, wherein the N^{th} order component is an N^{th} order component of which a coefficient of determination R² is 90% or more.

16. The apparatus of claim 14, wherein the order component is determined from a vibration sensor configured to detect the vibration signal of the EV motor.

17. The apparatus of claim 14, wherein the virtual engine RPM is determined by Equation 1,
$$Virtual engine RPM = actually measured motor RPM \times gear ratio of the number of virtual target stages . \qquad [ Equation 1 ]$$

18. The apparatus of claim 14, wherein for the virtual gear stage number, a difference between a virtual target gear stage and a virtual current gear stage is caused by a transmission proceeding rate of Equation 2,
$$Transmission proceeding rate = ( virtual engine RPM - current gear stage RPM ) / ( target gear RPM - current gear stage RPM ) \times 100 \% . \qquad [ Equation 2 ]$$

19. The apparatus of claim 14, wherein the processor is further configured for outputting the set EV mode traveling sound,
adjusting an output volume by applying a frequency band-pass filter based on the RPM of the EV motor before the outputting,
adjusting the output volume by imposing a weighting value on the RPM of the EV motor before the outputting,
adjusting the output volume by imposing a weighting value on a pedal opening amount before the outputting, or
adjusting the output volume by determining a vehicle speed differential change value from vehicle speed data before the outputting.

20. The apparatus of claim 14, wherein in the setting of the EV mode traveling sound, the order components according to a change in the traveling mode are disposed selectively.
